(19) United States
(12) Patent Application Publication
(10) Pub. No.: US 2017/0096852 A1
(43) Pub. Date: Apr. 6, 2017

(54) GARAGE DOOR SECURITY PLATE ASSEMBLY AND METHOD OF USE

(71) Applicant: Thomas A. Mello, II, Scottsdale, AZ (US)

(72) Inventor: Thomas A. Mello, II, Scottsdale, AZ (US)

(21) Appl. No.: 15/227,174

(22) Filed: Aug. 3, 2016

Related U.S. Application Data
(60) Provisional application No. 62/236,069, filed on Oct. 1, 2015.

(51) Int. Cl. E06B 7/28; E06B 3/44

(52) U.S. Cl. CPC E06B 7/28; E06B 3/44

(57) ABSTRACT

A garage door security plate assembly is disclosed. The garage door security plate assembly mounts to a connecting arm of a garage door opener. The garage door security plate assembly restricts access to an emergency release mechanism from an exterior of a garage door while not restricting operation of the garage door opener or operation of the emergency release mechanism from an interior side of the garage door.

### CROSS REFERENCE TO RELATED APPLICATION[S]

This application claims priority to U.S. Provisional Patent Application entitled “Garage Door Security Plate Assembly and Method of Use,” Ser. No. 62/236,069, filed Oct. 1, 2015, the disclosure of which is hereby incorporated entirely herein by reference.

### BACKGROUND OF THE INVENTION

Technical Field

This invention relates to a garage door security plate assembly, a combination garage door and garage door security plate assembly, and method of use.

State of the Art

Residential garage door openers generally have a horizontal drive mechanism that connects to the top middle of a garage door. The horizontal drive mechanism generally includes a guide track, a drive mechanism and means for connecting the drive mechanism to the garage door. Access to the garage door is generally by an encoded remote control receiver that causes activation of the garage door opener upon receipt upon the encoded signal. The connection point to the drive mechanism generally includes an emergency release rope to be manually opened in a power outage.

Garage doors are traditionally weak links in garage security, giving thieves easy access to your home. The typical garage door break in takes less than a few minutes, with some as quick as 6 seconds.

Accordingly, what is needed is a garage door security assembly that provides a simple, durable, reliable break in deterrent shield that inhibits the ability for a simple coat hook from accessing the release mechanism and/or emergency rope on the garage opener track assembly.

### DISCLOSURE OF THE INVENTION

The present invention relates to a garage door security plate assembly and method of use. The garage door security plate assembly includes a plate that is mountable to a connecting arm of a garage door opener that restricts access to a release mechanism of the garage door opener.

An embodiment includes a garage door security plate assembly comprising: a plate having a plurality of apertures; a channel bracket; and a fastener, wherein the fastener secures the plate to a connecting arm of a garage door opener using the channel bracket, and wherein the plate is located between a garage door and a release mechanism of the garage door opener.

Another embodiment includes a garage door security system comprising: a garage door; a garage door opener coupled to the garage door to open and close the garage door, wherein the garage door opener includes; a connecting arm coupled on one end to the garage door and on an opposing end to a trolley operatively coupled to an overhead guide rail of the garage door opener; and a release mechanism operatively coupled within the trolley to the overhead guide rail; and a garage door security plate assembly comprising: a plate having a plurality of apertures; a channel bracket; and fasteners, wherein the fasteners secure the plate to a connecting arm of a garage door opener using the channel bracket, and wherein the plate is located between a garage door and a release mechanism of the garage door opener.

Another embodiment includes a method of using a garage door security plate assembly comprising: mounting a plate of a garage door security plate assembly to a connecting member of a garage door opener, wherein the plate is located adjacent a trolley of the garage door opener and between a garage door and a release mechanism of the trolley; and restricting access to a release mechanism from an exterior side of a garage door in response to mounting the plate adjacent the trolley of the garage door opener.

The foregoing and other features and advantages of the invention will be apparent to those of ordinary skill in the art from the following more particular description of the invention and the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1A is a rear view of a garage door security plate assembly according to an embodiment;

FIG. 1B is a perspective view of a garage door security plate assembly according to an embodiment;

FIG. 2 is a perspective view of a garage door operated by a motorized garage door opener and a garage door security plate assembly coupled thereto in accordance with an embodiment;

FIG. 3 is a perspective view of a garage door security plate assembly coupled to a connecting arm adjacent a trolley in accordance with an embodiment; and

FIG. 4 is a flowchart of a method of using a garage door security plate assembly according to an embodiment.

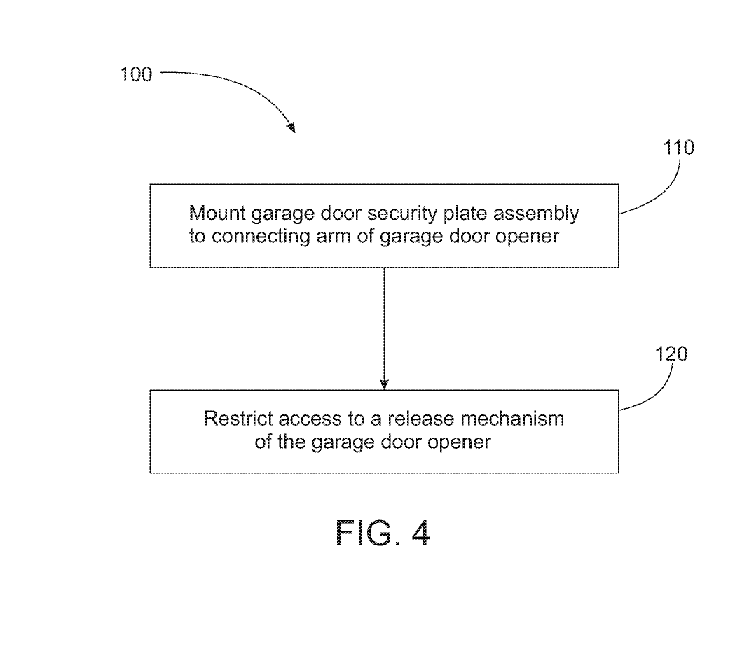

### DETAILED DESCRIPTION OF EMBODIMENTS OF THE INVENTION

As discussed above, embodiments of the present invention relate to a garage door security plate assembly and method of use.

The disclosed garage door security plate assembly is compatible with overhead garage door openers having a modern sectional configuration, including, but not limited to, Genie™, Liftmaster™, Guardian™ and Sommer™.

The disclosed assembly allows for easy access to the emergency release rope of a garage door mechanism, while still blocking intruders from reaching the emergency release rope from the outside. The disclosed assembly does not require tools to install on a garage door. All attachment means, including, but not limited screws and retainers can be used by hand

In one embodiment, the garage door security plate assembly comprises a flush mount designed deflection plate, retention screws, and a channel formed adapter plate. The disclosed garage door security plate assembly may be installed in as little as about 6 seconds, about the same amount of time a burglar could conceivably break into your garage. The garage door security plate assembly is attached to a garage door connection arm, such as a J-arm. The disclosed garage door security plate assembly may be constructed of any type of material. One material, for example, may be a plastic, such as acrylonitrile butadiene styrene (ABS) plastic and/or steel.

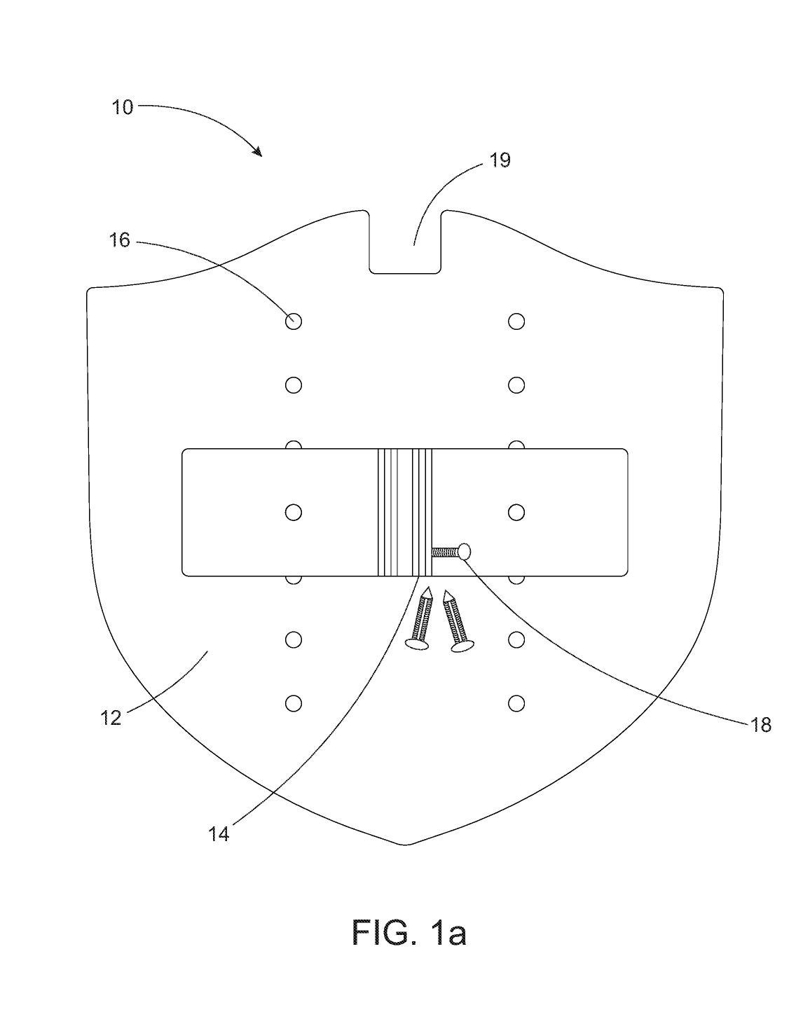

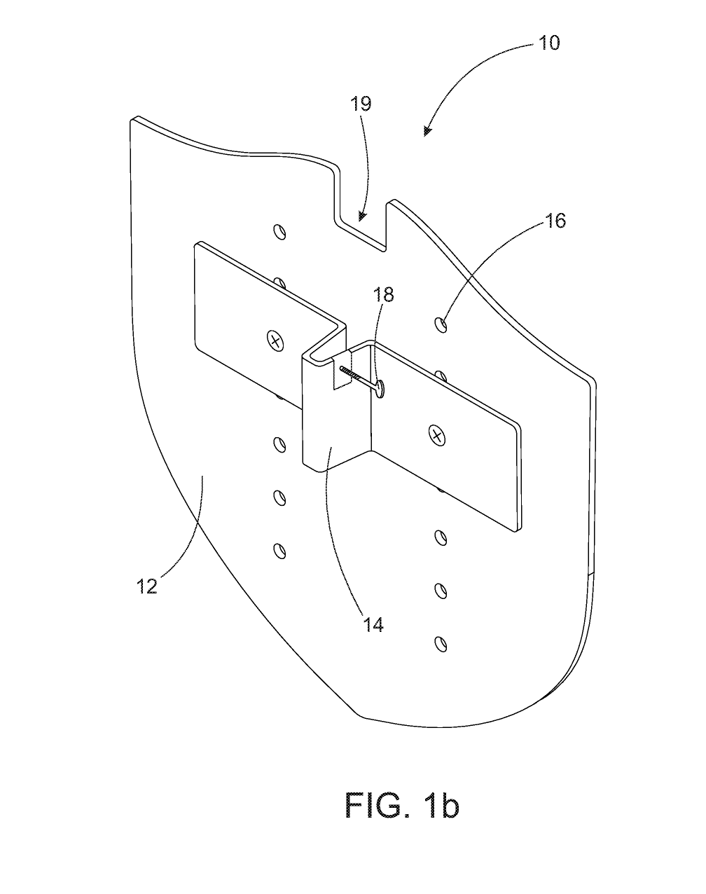

FIGS. 1A and 1B depict a garage door security plate assembly 10 having a plate (shield) 12 and a channel bracket 14. Channel bracket 14 may be coupled to the plate 12 in a plurality of adjustable positions through a series or plurality of corresponding apertures 16 with fasteners 18. Fasteners 18 may be screws, snap fasteners or any other type of fastener that can couple channel bracket 14 to plate 12. Cutout 19 facilitates mounting and further provides an opening to prevent the plate 12 from interfering with proper operation of a garage door opener, when the plate 12 is mounted to a connecting arm of the garage door opener.

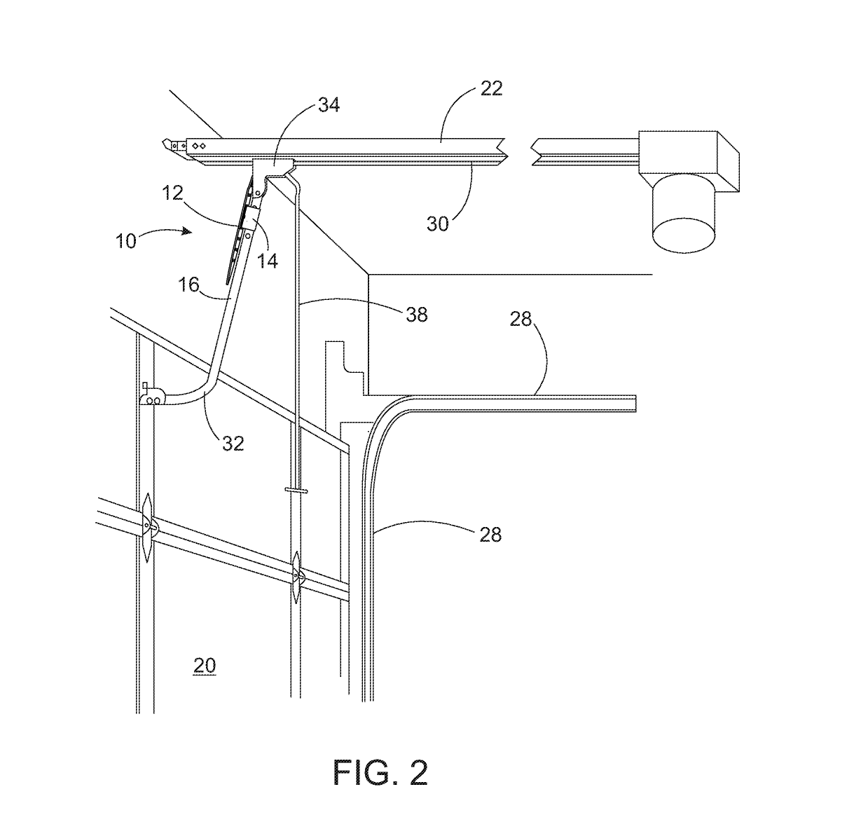

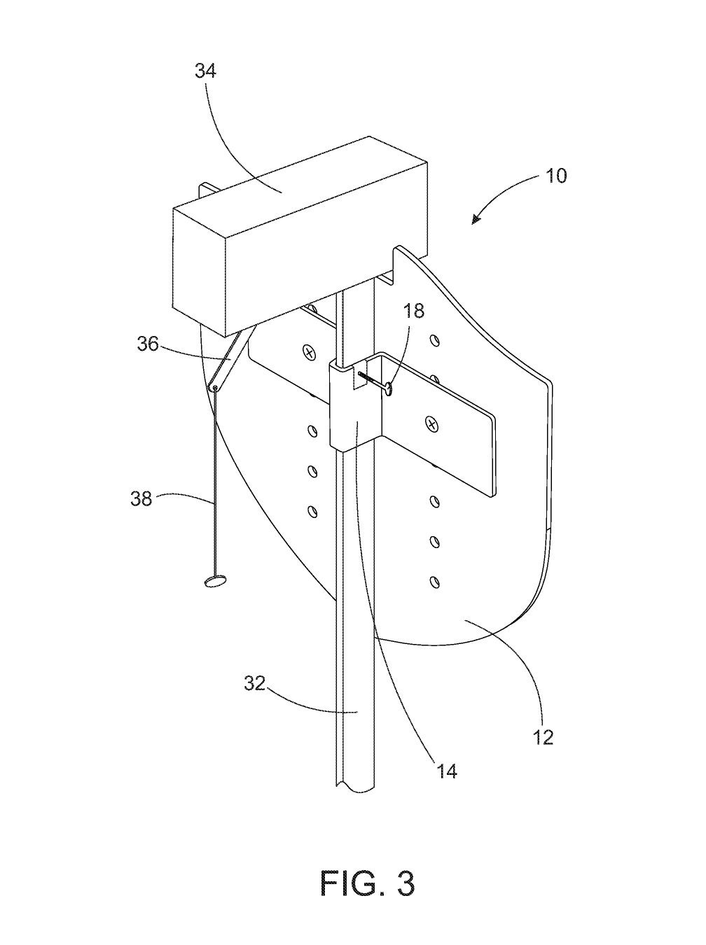

FIGS. 2 and 3 shows a portion of garage door 20 coupled to a motorized garage door opener 22 by means of a connecting arm 24 and a release mechanism 26. Garage door 20 may be supported at opposing ends by a weight bearing rail 28 engaged by wheels mounted to garage door 20. Garage door opener 22 generally includes an overhead guide rail 30 and an inner drive mechanism (not shown) of any suitable means. The inner drive mechanism (not shown) is connected to connecting arm 32 by a trolley 34 having a release mechanism 35. Release mechanism 35 allows release or disconnection of the connecting arm 32 with the inner drive mechanism by manual activation of lever 36 by force applied on an emergency release rope 38.

Plate 22 may be coupled to connecting arm 32 by channel bracket 14. Channel bracket 14 receives a portion of connecting arm 32 within the channel and then is coupled to plate 22. This couples plate 22 to connecting arm 32. Further, plate 22 when coupled to connecting arm 32 is located at a trolley 34. Cutout 19 operates to receive trolley 34 within cutout 19, thereby extending plate 12 on opposing sides of trolley 34 and extending down from trolley 34. This restricts access to release mechanism 35 from an intruder located on an exterior side of garage door 20. Further, plate 12 when coupled to connecting arm 32 is located between garage door 20 and release mechanism 34. This secures the release mechanism 35 from being disengaged from an exterior side of garage door 20.

Cutout 19 also serves to allow proper function of garage door opener 22 while garage door security plate assembly 10 is coupled to connecting arm 32. During opening and closing of garage door 20, connecting arm 32 may rotate about pivotably mounted ends. Cutout 19 allows connecting arm and plate 12 to rotate without contacting or interfering with operation of the trolley 34 along track 30.

FIG. 3 is a schematic flow-chart representation of a method 100 of using the disclosed garage door security plate assembly. Method 100 comprises mounting a plate of a garage door security plate assembly to a connecting member of a garage door opener (Step 110), wherein the plate is located adjacent a trolley of the garage door opener and between a garage door and a release mechanism of the trolley. The method 100 also includes restricting access to a release mechanism from an exterior side of a garage door in response to mounting the plate adjacent the trolley of the garage door opener (Step 120).

Step 110 of mounting the plate may comprise receiving the trolley within a cutout of the plate. Step 110 may also include using a channel bracket to secure the plate to the connecting arm. Using the channel bracket to secure the plate to the connecting arm comprises selecting a set of apertures from the series of sets of apertures in the plate to secure the channel bracket to.

Method 100 may also include operating the garage door opener with the garage door security plate assembly coupled to the connecting arm. In this way, the garage door security plate assembly restricts and prevents an intruder from disengaging the release mechanism of a garage door and gaining access to the garage while still allowing the garage door opener to function properly.

The components defining any garage door security plate assembly may be formed of any of many different types of materials or combinations thereof that can readily be formed into shaped objects provided that the components selected are consistent with the intended operation of a garage door security plate assembly. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any garage door security plate assembly may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

What is claimed is:

1. A garage door security plate assembly comprising:
a plate having a plurality of apertures;
a channel bracket; and
a fastener, wherein the fastener secures the plate to a connecting arm of a garage door opener using the channel bracket, and wherein the plate is located between a garage door and a release mechanism of the garage door opener.

2. The garage door security plate assembly of claim 1, wherein the plate is a shield.

3. The garage door security plate assembly of claim 1, wherein the plate further comprises a cutout.

4. The garage door security plate assembly of claim 3, wherein the cutout receives a trolley of the garage door opener within the cutout when the plate is coupled to the connecting arm.

5. The garage door security plate assembly of claim 1, wherein the fastener is a screw.

6. The garage door security plate assembly of claim 1, wherein the assembly is constructed of a polymer material.

7. The garage door security plate assembly of claim 6, wherein the polymer material comprises acrylonitrile butadiene styrene.

8. A garage door security system comprising:
a garage door;
a garage door opener coupled to the garage door to open and close the garage door, wherein the garage door opener includes:
a connecting arm coupled on one end to the garage door and on an opposing end to a trolley operatively coupled to an overhead guide rail of the garage door opener; and
a release mechanism operatively coupled within the trolley to the overhead guide rail; and
a garage door security plate assembly comprising:
a plate having a plurality of apertures;
a channel bracket; and
fasteners, wherein the fasteners secure the plate to a connecting arm of a garage door opener using the channel bracket, and wherein the plate is located between a garage door and a release mechanism of the garage door opener.

9. The system of claim 8, wherein the fastener is a screw.

10. The system of claim 8, wherein the connecting arm is a J-arm.

11. The garage door security plate assembly of claim 8, wherein the plate is a shield.

12. The garage door security plate assembly of claim 8, wherein the plate further comprises a cutout.

13. The garage door security plate assembly of claim 12, wherein the cutout receives a trolley of the garage door opener within the cutout when the plate is coupled to the connecting arm.

14. The garage door security plate assembly of claim 8, wherein the assembly is constructed of a polymer material.

15. The garage door security plate assembly of claim 14, wherein the polymer material comprises acrylonitrile butadiene styrene.

16. A method of using a garage door security plate assembly comprising:
mounting a plate of a garage door security plate assembly to a connecting member of a garage door opener, wherein the plate is located adjacent a trolley of the garage door opener and between a garage door and a release mechanism of the trolley; and
restricting access to a release mechanism from an exterior side of a garage door in response to mounting the plate adjacent the trolley of the garage door opener.

17. The method of claim 16, wherein mounting the plate comprises receiving the trolley within a cutout of the plate.

18. The method of claim 16, wherein mounting the plate includes using a channel bracket to secure the plate to the connecting arm.

19. The method of claim 18, wherein using the channel bracket to secure the plate to the connecting arm comprises selecting a set of apertures from the series of sets of apertures in the plate to secure the channel bracket to.

20. The method of claim 19, further comprising operating the garage door opener with the garage door security plate assembly coupled to the connecting arm.
